(19) United States
(12) Patent Application Publication
(10) Pub. No.: US 2006/0034081 A1
(43) Pub. Date: Feb. 16, 2006

(54) Cellular phone with illumination and red lense capability

(76) Inventor: Kathryn Kelley Panko, Oconomowoc, WI (US)

Correspondence Address: KATHRYN PANKO, 231N. FOWLER ST. #301, OCONOMOWOC, WI, 53066, US

(21) Appl. No.: 10/925,472

(22) Filed: Aug. 11, 2004

(51) Int. Cl. F21V 33/00

(52) U.S. Cl. 362/253

(57) ABSTRACT

The Cellular Phone with illumination and Red Lens Capability will provide illumination in the form of either Red Lens Capability or Clear Lens Capability throughout areas on the cell phone to include the display screens in both the open and closed positions as well as provide illumination to the user in such a manner as to illuminate an area in front of the user.

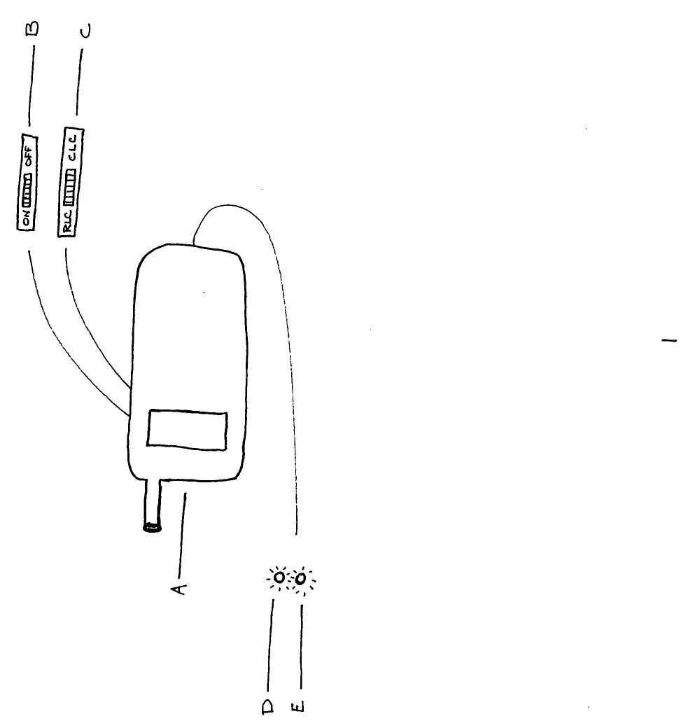

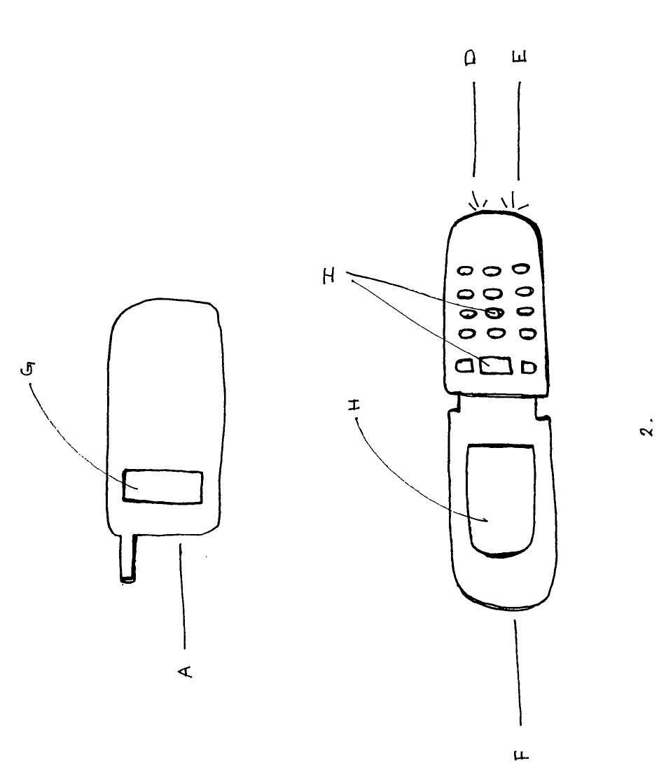

The illumination is provided on the cell phone in the following locations; the illumination located at the bottom of the phone (D) and (E) as well as the display screen on the cell phone located in the closed position (G), the display screen located in the open position (H) and the key pad located in the open position (I). The illumination at the locations of (D), (E), (G), (H) and (I) may be switched from Red Lens Capability to Clear Lens Capability by the use of the RLC and CLC switch located on the side of the phone (C).

The use of the RLC and CLC switch (C) will not impact the use of the illumination provided at bottom of the phone (D) and (E) as well as the display screen on the cell phone located in the closed position (G), the display screen located in the open position (H) and the key pad located in the open position (I), it will however change the illumination provided at bottom of the phone (D) and (E) as well as the display screen on the cell phone located in the closed position (G), the display screen located in the open position (H) and the key pad located in the open position (I), from either Red Lens Capable or Clear Lens Capable. The illumination provided at the bottom of the cell phone (D) and (E) will provide illumination in the form of either Red Lens Capability or Clear Lens Capability through switching the switch located on the side of the phone (C). The illumination provided by (D) or (E) will provide illumination in front of the user in such a manner as to light an area in front of the user. The intended use of the illumination located at the bottom of the cell phone (D) and (E) is not intended to illuminate the cell phone, its intended use is to provide illumination to the user in front of the user. The illumination in this location (D) and (E) may be used while the cell phone is being used for its intended use or while the cell phone is not being used. The illumination at this location (D) and (E) may be turned on or off by the use of the on/off switch located on the side of the cell phone (B), this switch will not impact the use of the illumination provided in the following areas; the display screen on the cell phone located in the closed position (G), the display screen located in the open position (H) and the key pad located in the open position (I).

1- The illumination is located in a manner such that the cell phone may or may not be in use at the time the illumination is provided at the bottom end of the cell phone in such a way as to illuminate an area in front of the user while the cell phone is being used in the manner of its intended use.

2- The Red Lens Capability and Clear Lens Capability will perform the same intended use functions and will be differentiated by either red lens illumination or clear lens illumination.

3- The illumination provided may be switched from Red Lens Capability to Clear Lens Capability through the use of the switch located on the side of the cell phone.

4- The RLC and CLC switch located on the side of the cell phone will switch the illumination provided to either Red Lens Capability or Clear Lens Capability in the following locations; the illumination located at the bottom of the phone as well as the display screen on the cell phone located in the closed position, the display screen located in the open position and the key pad located in the open position.

5- The illumination located at the bottom of the phone may be switched on or off by the use of the on/off switch located on the side of the cell phone. The illumination on/off switch will not impact the use of the illumination provided on the display screen on the cell phone located in the closed position, the display screen located in the open position and the key pad located in the open position.
